(19) United States
(12) Patent Application Publication
(10) Pub. No.: US 2026/0289230 A1
(43) Pub. Date: Sep. 24, 2026

(54) GENERATING INSIGHTS BY ASSIGNING DIFFERENTIAL IMPORTANCE

(71) Applicant: Wells Fargo Bank, N.A., San Francisco, CA (US)

(72) Inventors: Fazal Ahmad Khan, Nagpur (IN); Anand Natarajan, Chennai (IN); Nageswara Rao Vejju, Hyderabad (IN)

(21) Appl. No.: 19/084,524

(22) Filed: Mar. 19, 2025

(51) Int. Cl. G06N 3/042; G06N 3/0475

(52) U.S. Cl. CPC G06N 3/042; G06N 3/0475

(57) ABSTRACT

Techniques are described for computer-based determination of significant attributes associated with a time series dataset and generation of technical insights for the time series dataset based on the significant attributes. The disclosed techniques include a computing system configured to obtain time series data of a metric, determine attribute values for a plurality of attributes associated with the time series data of the metric, obtain ranking values for the plurality of attributes, assign an importance value to each respective attribute of the plurality of attributes associated with the time series data of the metric based on an attribute value of the respective attribute and a ranking value of the respective attribute, and generate at least one technical insight for the time series data of the metric based on the respective attribute having a largest importance value of the plurality of attributes associated with the time series data of the metric.

### TECHNICAL FIELD

This disclosure relates to computing systems, and more specifically, computing systems configured to generate insights for time series data.

### BACKGROUND

Organizations may use advanced algorithms and/or machine learning techniques to analyze stored and/or streaming data and generate insights. Organizations may use these insights to make decisions and/or improve devices and/or systems.

### SUMMARY

In general, this disclosure describes techniques for computer-based determination of significant attributes associated with a time series dataset and generation of technical insights for the time series dataset based on the significant attributes. The disclosed techniques enable automated determination of the significant attributes for a dataset by determining which attributes indicate trends in the dataset over time and assigning an importance value or weight to each attribute based on the duration and timing of the trends. The techniques automatically generate technical insights based on the one or more attributes that have the largest importance values for the dataset. The technical insights may then be used to modify other computing systems or modify functions performed by other computing systems.

Conventionally, organizations may use computer-based algorithms and/or machine learning techniques to generate data insights based on metric targets and attributes identified by data owners or stakeholders. While certain metrics are easily measurable and comparable to target ranges, other metrics may lack any real target and cannot be easily evaluated to determine significance of current values of the metrics. For data-heavy organizations, such as financial institutions, these struggles are compounded when attempting to determine data insights from time series data across multiple platforms with hundreds or thousands of metrics.

The techniques of this disclosure may provide one or more technical improvements that may be used to realize practical advantages. For example, the techniques enable a computing system to dynamically score or assign importance values to attributes associated with time series data of a metric to determine which attributes indicate the most significant trends in the data without human input from data owners or other stakeholders associated with the data. The computing system may also eliminate assignment bias in the importance values assigned to each attribute and use the bias-free importance values to generate the technical insights. These techniques may provide a more accurate determination of the significant attributes, and consequently more impactful technical insights, associated with a particular time series dataset of the metric than a static determination of significant attributes or targets for the metric. The techniques may achieve increased accuracy by removing bias, both in terms of eliminating human selection and eliminating preferential assignment inherent in some algorithms, to ensure an increasing order of importance over time to identify the most significant trends in the time series data.

As another example, the computing system may generate ranking values for the attributes associated with the time series data of the metric using one or more generative artificial intelligence (AI) models, such as a large language model (LLM). The generative AI models may be trained to generate a ranking of attributes that indicates a priority order of the attributes for the metric. Using generative AI models to generate the rankings eliminates the use of human determined and/or static priority rankings of the attributes, which may introduce bias or become outdated and inaccurate over time as the data changes.

In this way, the techniques enable determination of most significant attributes of time series data of a metric and generation of technical insights that may not be possible using manual data analysis. For example, while drawing technical insights based on small sets of trend data and translating it to a narrative can be performed manually, doing it across large amounts of trend data with hundreds or thousands of metrics would not only be time-consuming but also prone to inconsistency and errors. In addition, when technical insights must be drafted as a narrative, it is imperative to prioritize various attributes (such as maximum, minimum, continuous increase, continuous decrease etc.) associated with a current window, e.g., 53 weeks, of time series data of a particular metric. Each of the attributes needs to be assigned a unique level of importance depending on patterns or behaviors observed in the current dataset. Such unique assignment of each attribute of each metric for each time window cannot be determined manually due to the large amount of data (e.g., dozens of attributes for each metric of hundreds or thousands of metrics) and time limitations (e.g., daily or weekly analyses).

In one example, this disclosure is directed towards a system comprising a memory; and one or more processors in communication with the memory and configured to obtain time series data of a metric, determine attribute values for a plurality of attributes associated with the time series data of the metric, obtain ranking values for the plurality of attributes, assign an importance value to each respective attribute of the plurality of attributes associated with the time series data of the metric based on an attribute value of the respective attribute and a ranking value of the respective attribute, and generate at least one technical insight for the time series data of the metric based on the respective attribute having a largest importance value of the plurality of attributes associated with the time series data of the metric.

In another example, this disclosure is directed towards a method comprising obtaining time series data of a metric, determining attribute values for a plurality of attributes associated with the time series data of the metric, obtaining ranking values for the plurality of attributes, assigning an importance value to each respective attribute of the plurality of attributes associated with the time series data of the metric based on an attribute value of the respective attribute and a ranking value of the respective attribute, and generating at least one technical insight for the time series data of the metric based on the respective attribute having a largest importance value of the plurality of attributes associated with the time series data of the metric.

In an additional example, this disclosure is direct towards a non-transitory computer-readable storage medium encoded with instructions that, when executed, cause at least one processor of a computing system to obtain time series data of a metric, determine attribute values for a plurality of attributes associated with the time series data of the metric, obtain ranking values for the plurality of attributes, assign an importance value to each respective attribute of the plurality of attributes associated with the time series data of the metric based on an attribute value of the respective attribute and a ranking value of the respective attribute, and generate at least one technical insight for the time series data of the metric based on the respective attribute having a largest importance value of the plurality of attributes associated with the time series data of the metric.

The details of one or more examples of the disclosure are set forth in the accompanying drawings and the description herein. Other features, objects, and advantages of the disclosure will be apparent from the description and drawings, and from the claims.

### BRIEF DESCRIPTION OF DRAWINGS

FIG. 1 is a block diagram illustrating an example network system including a computing system configured to generate technical insights based on significant attributes of time series data of a metric, in accordance with one or more aspects of this disclosure.

FIG. 2 is a conceptual diagram illustrating an example computing system configured to assign importance values to attributes of time series data of a metric and generate technical insights for the time series data of the metric based on most significant attributes, in accordance with one or more aspects of the present disclosure.

FIG. 3 is a flow diagram illustrating example operations of training one or more machine learning (ML) models to generate a set of ranking values for attributes, in accordance with one or more techniques of this disclosure.

FIG. 4 is a block diagram illustrating an example computing system, in accordance with one or more aspects of the present disclosure.

FIG. 5 is a flow diagram illustrating an example operation of generating technical insights based on significant attributes of time series data of a metric, in accordance with one or more aspects of the present disclosure.

FIG. 6 is a flow diagram illustrating an example operation of assigning importance values to attributes of time series data of a metric and generating technical insights for the time series data of the metric based on most significant attributes, in accordance with one or more techniques of this disclosure.

### DETAILED DESCRIPTION

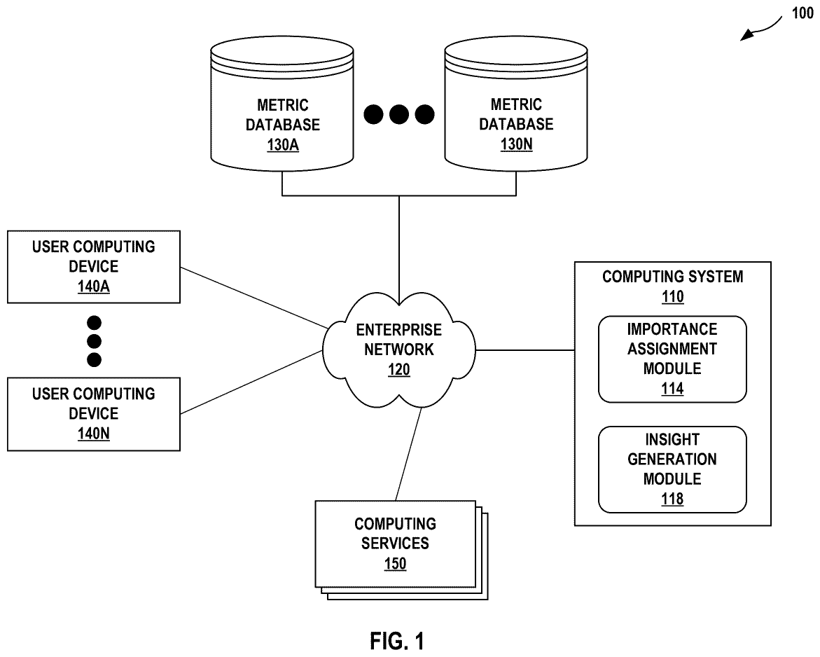

FIG. 1 is a block diagram illustrating an example network system 100 including a computing system 110 configured to generate technical insights based on significant attributes of time series data of a metric, in accordance with one or more aspects of this disclosure. In the example of FIG. 1, network system 100 includes enterprise network 120. Enterprise network 120 may be a large-scale enterprise network used or administered by a large organization, such as a financial institution, bank, medical facility, or other type of large organization, which will commonly rely on significant computing resources. For some large organizations, computing and storage resources may be provided through multiple data centers (not shown) deployed within enterprise network 120. Moreover, various applications, services, or other tools used by employees or other users of the organization may be accessible either within enterprise network 120 or from various cloud-based service providers accessible via enterprise network 120.

Devices connected to enterprise network 120 may be part of a secure network not normally accessible to the public. Although enterprise network 120 is illustrated as a single network and may be principally located within one location, enterprise network 120 may also comprise multiple networks and be geographically distributed across multiple locations. A number of devices and/or systems are shown connected to enterprise network 120 in FIG. 1. Such devices and systems include computing system 110, user computing devices 140A-140N (collectively, “user computing devices 140”), metric databases 130A-130N (collectively, “metric databases 130”), and computing services 150.

Enterprise network 120 may include or represent any public or private communications network or other network. One or more client devices, server devices, or other devices may transmit and receive data, commands, control signals, and/or other information across such networks using any suitable communication techniques. In some examples, enterprise network 120 may be a separate network as illustrated in FIG. 1 or may be a subnetwork of another network. In other examples, enterprise network 120 may be combined with another network (not illustrated) to form a single network; further, one or more of such networks may be, or may be part of, the internet. Accordingly, one or more of the devices or systems illustrated in FIG. 1 may be in a remote location relative to one or more other illustrated devices or systems. Enterprise network 120 may include one or more network hubs, network switches, network routers, network links, satellite dishes, telecommunication infrastructure equipment, or any other network equipment. Such devices or components may be operatively inter-coupled, thereby providing for the exchange of information between computers, devices, or other components (e.g., between one or more user devices or systems and one or more server devices or systems).

User computing devices 140 may be devices that are used by one or more users of enterprise system 100. User computing devices 140 may represent standard devices that are utilized by one or more employees of the organization. For instance, in one example, user computing device 140A may be a laptop computer utilized by an HR employee of the organization. In another example, user computing device 140B may be a desktop computer utilized by a technician working within the organization. Each of user computing devices 140 may interact with other systems, devices, and components across enterprise network 120. In some examples, one or more of user computing devices 140 may be configured with varying levels of heightened (e.g., administrative) access to one or more network resources (e.g., databases, systems, devices, etc.) that are otherwise inaccessible to standard users of system 100. User computing devices 140 with higher levels of access may be distinguished from other computing devices through software restrictions (e.g., account credentials) or hardware restrictions (e.g., MAC address filtering).

Computing services 150 may be computing services (e.g., standalone computing services, a collection of computing services operating on within a computing system, etc.) administered by a large organization (e.g., the organization managing enterprise network 120), such as a financial institution, bank, medical facility, or other type of large organization, which may commonly rely on significant computing resources. Computing services 150 may include any technical software or hardware component (or combination therein) hosted on and/or managed by computing services 150. For instance, computing services 150 may include scripts, automated tools, applications, databases, computing devices and/or systems, microservices, and other technical components.

Computing services 150 may be configured to assist in the management and/or operations of the organization. For instance, one of computing services 150 (e.g., hosted and/or managed by a computing system) may be configured to assist with the operations of a contact center of an organization. The computing services may assist in communicating with one or more individuals (e.g., customers of the organization), storing information (e.g., call data, efficiency information, customer information, etc.), and providing information to employees of the organization (e.g., information on customers, incoming communications, etc.). In some examples, computing services 150 may be accessed by, or configured to perform operations in response to one or more commands or requests from any of user computing devices 140. For instance, one of user computing devices 140, such as a device with heightened (e.g., administrative) access, may access one of computing services 150. In some examples, any of user computing devices 140, such as devices without administrative access to a system, may be prohibited from accessing and/or communicating with the computing system (e.g., one of computing services 150).

Each of computing services 150 may collect a multitude of information related to the operation or performance of a computing system (e.g., the computing system that manages a given computing service) and/or the given computing service. The information stored and/or collected by computing services 150 may be one or more metrics that are used to measure or otherwise evaluate the performance of the computing system or associated organization. For instance, one of computing services 150, such as a computing service utilized by a contact center, may collect information about the performance of the contact center, such as the number of calls interacted with (e.g., answered, received, declined, etc.) in a given time period (e.g., an hour, a day, a week, a month, etc.) or the average handle time (e.g., the average time an individual spends on a call) for the given time period. In another example, one of computing services 150, such as a computing service for a bank office, may collect information related to the performance of the bank, such as loan origination volume, average loan size, loan application volume, or loan servicing issues. Each of computing services 150 may store various metrics and/or other information pertaining to the operation or performance of the computing system in one or more databases, such as metric databases 130.

Metric databases 130 may represent any suitable data structure or storage medium for storing information related to logs and/or data from one or more of computing services 150. In some examples, data in metric databases 130 may represent a system of record associated with an enterprise network 120, which may serve as an authoritative data source for at least some data pertaining to enterprise network 120, or pertaining to the operations of the business, organization, or other entity that administers enterprise network 120. In other examples, data in metric databases 130 may represent information generated by computing services 150, or components therein, such as one or more metrics. In some examples, metric databases 130 may be updated and/or maintained by any computing services 150.

In some examples, each of computing services 150 may have an individual database (e.g., one of metric databases 130) in which metrics associated with the computing service are stored. In other examples, computing services 150 may store information related to a single metric in a single one of metric databases 130. In other examples, computing services 150 may store information related to one or more metrics in any of metric databases 130.

In some examples, the metrics stored in metric databases 130 may be completed values. For instance, when one of computing services 150 stores data related to the average handling time for a given twenty-four-hour period, the data stored for a given time period may be the average handling time value. In other examples, the metrics stored in metric database 130 may be data that is used to determine a completed value. For instance, in the scenario of the previous example, the data stored may be the handling times of each call that occurred in the time period. As such, in some examples, the data may be used to determine the complete value of a metric.

Users of user computing devices 140 may include data analysts who may attempt to use metrics in metric databases 130 and other data to determine one or more technical insights regarding the metrics. For instance, one of user computing devices 140 may analyze metric data associated with a contact center to track and improve the health of the organization. The user may attempt to generate various technical insights regarding the contact center, such as what events may have led to a target call volume being met or not met. Conventionally, users may attempt to manually generate one or more technical insights from the metric data. However, the user may encounter issues when attempting to generate insights across large amounts of trend data (e.g., with hundreds or thousands of metrics and/or attributes). A user may be unable to generate insights due to an inability to manually identify trends or patterns across a large quantity of data. For example, with dozens of attributes for each metric, and hundreds or thousands of metrics being used to evaluate a single computing system, a user may be unable to identify the most important or most significant trends or patterns associated with each metric even when dealing with relatively short periods of time (e.g., seven one-day time periods), due to the impossibility of the human mind to accurately and efficiently determine attribute values and attribute trends across the time series for all attributes of all metrics. As such, the user may be unable to determine valuable insights from the dataset.

In addition, conventional computing systems configured to assist in generating insights from data may also be unable to accurately and efficiently generate insights from the metric data. For example, a conventional computing system may be unable to automatically identify the most important or most significant attributes of one or more metrics. Thus, conventional computing systems may attempt to generate insights for all attributes of each metric, which results in excessive computing resource usage, time consuming analyses, and delayed results that still may not provide actional insights from the dataset. Alternatively, convention computing systems may attempt to generate insights for one or more user identified or randomly selected attributes of each metric, which may result in reduced accuracy of the technical insights and redundant processing as the analyses are rerun.

This disclosure describes techniques for a computing system (e.g., computing system 110) to automatically identify significant attributes of metrics and generate technical insights for the metrics, and accompanying narrative explanations, across large sets of time-series data. In accordance with one or more techniques of this disclosure, computing system 110 may use importance assignment module 114 and insight generation module 118 to obtain data from metric databases 130 to identify the significant attributes and generate the technical insights.

Computing system 110 may be configured to obtain time-series data of a metric from one or more of metric databases 130 for each time period of a plurality of time periods within a window of time. For example, the obtained time series data of the metric may comprise a value of the metric for each week over 53 weeks. For a given metric, computing system 110 may obtain the data over multiple time periods to determine how the metric changes over time. For instance, in one example, computing system 110 may obtain data related to the metric as measured on a daily basis (e.g., the metric data as measured in each individual twenty-four-hour period). In another example, computing system 110 may obtain data related to the metric as measured on a weekly basis (e.g., the metric data as measured in each individual seven-day period). Computing system 110 may determine a window of time from which to obtain the time series data. For instance, in one example, computing system 110 may collect daily data from the last twenty-eight-day period. In another example, computing system 110 may collect weekly data from the last fifty-two-week period.

In some examples, the data obtained by computing system 110 from metric databases 130 may undergo one or more data validation operations. Computing system 110 may analyze the time series data to find and remove errors (e.g., unreadable characters, datatypes, etc.), inconsistencies, duplications, and missing entries from the dataset. For instance, computing system 110 may be configured to remove a metric from subsequent analysis when the metric is missing a certain threshold of data from the time period. For instance, if computing system 110 is analyzing daily metric data (e.g., for multiple separate metrics) across a twenty-eight-day period, computing system 110 may be configured to drop any metric that is missing information for at least seven days.

After obtaining the metric time series data from metric databases 130, computing system 110 may generate one or more computational measurements and/or attributes that may be used to measure (e.g., grade, compare, etc.) a metric from the metric time series data. For instance, computing system 110 may create attributes such as target met and target not met (e.g., whether the value for a metric met a target assigned by the organization managing enterprise network 120) or maximum and minimum. In some examples, computing system 110 may create one or more attributes that involve one or more comparisons to other time periods in the time series data. For instance, computing system 110 may determine one or more attributes based on whether the value of a metric is continuously increasing, continuously decreasing, staying stagnant, etc. To determine the value of the attribute at a given point, computing system 110 may analyze multiple previous time periods to determine factors such the duration of the increase/decrease, the rate of increase/decrease, the acceleration of the increase/decrease, the maximum value during the period of the increase/decrease, the minimum value during the period of the increase/decrease, or the average value during the period of the increase/decrease. Computing system 110 may use these factors to determine a value of an attribute for a metric a given time period. For instance, if a value has been continuously increasing for five weeks, the value of the attribute at week five may be higher than the value of the attribute at week four (e.g., since the duration of the increase is longer at week five).

Computing system 110 may be configured to obtain ranking values for each attribute used to evaluate a metric. For instance, computing system 110 may select continuous increase, continuous decrease, target met, and target not met as the set of attributes used to measure a metric. Computing system 110 may obtain a ranking of the attributes, wherein each attribute is given a unique rank within the set of attributes associated with the metric. For instance, computing system 110 may obtain a ranking of target met, target not met, continuous increase, continuous decrease, wherein target met may be the highest ranked (e.g., most important or most significant) attribute and continuous decrease may be the lowest ranked (e.g., least important or least significant) attribute. In some examples, computing system 110 may obtain the ranking data from one or more generative artificial intelligence (AI) models (not shown in FIG. 1). For instance, computing system 110 may communicate with one or more generative AI models, such as a large language model (LLM), which may generate the ranking data. In other examples, the ranking data may be obtained from one or more users of computing system 110 (e.g., employees of the organization managing enterprise system 100). For instance, in one example, computing system 110 may obtain the ranking data from one or more managers of the organization (e.g., by communicating with any of user computing devices 140, receiving input at one or more graphical user interfaces of computing system 110, etc.).

Importance assignment module 114 of computing system 110 may be configured to assign a unique weight, or importance value, to each attribute associated with the time series data of the metric. Importance assignment module 114 may be configured to dynamically assign the importance value to each attribute. Importance assignment module 114 may be configured to assign unique differential importance values to each attribute. Importance assignment module 114 may be configured to assign the importance values based on the value of each attribute. For instance, importance assignment module 114 may be configured to assign importance values such that a first attribute with a value higher than a second attribute may be assigned an importance value higher than the second attribute. Importance assignment module 114 may be configured to assign the importance values based on the ranking value of each attribute. For instance, when a first attribute and a second attribute have the same value, but the first attribute is ranked higher than the second attribute, the first attribute may be given a higher importance value than the second attribute. In such ways, the importance value of any attribute may be proportional to the value of the attribute, such that an increase or decrease in the value of the attribute may increase or decrease the importance value of the attribute, respectively.

For instance, in one example of importance assignment module 114 assigning importance values, importance assignment module 114 may evaluate attributes of a metric during a window of time in the time series data. The metric being measured may be evaluated by three attributes, e.g., target met, target not met, and continuous increase. The attributes may be ranked such that target met is ranked highest, and continuous increase is ranked lowest. The attributes may have a value of two, zero, and four, respectively, indicating that a target has been met for the past two time periods of the time series data, and that the metric has been continuously increasing for the past four time periods. In accordance with these values, importance assignment module 114 may assign an importance value to each attribute, such that target met may have the highest importance value, while target not met may have the lowest importance value (e.g., due to the value of continuous increase being significantly higher than target not met).

In some instances, the importance values assigned by importance assignment module 114 may include one or more instances of bias or preferential assignment. That is, in some instances, importance assignment module 114 may generate higher importance values for an attribute based on attribute values at less recent points in the time than for more recent points in time (e.g., disregarding the time horizon impact of the attribute values). For instance, importance assignment module 114 may generate importance values for a metric across a fifty-two-week period. Importance assignment module 114 may assign a lower importance value for one attribute at week ten in the time series data than for another attribute at week three in the time period. As such, importance assignment module 114 may be configured to eliminate bias and preferential assignment in the importance values by increasing the impact of the time horizon in the time series data. For instance, in some examples, importance assignment module 114 may be configured to ensure that, for each time period in the time series data, each importance value is at least equal to the highest importance value of an attribute in the previous time period. For instance, if, at one time period in the time series data, the highest importance value for a set of attributes is ten, importance assignment module 114 may be configured to transform the importance values for the set of attributes in the next time period in the time series data so that the lowest importance value is at least equal to ten.

Insight generation module 118 may be configured to select the one or more importance values associated with the time series data of the metric with the most significance (e.g., highest values). For instance, in one example, insight generation module 118 may determine that the most significant (e.g., highest) importance values associated with a fifty-two-week period of time is associated with a target being met for fifteen weeks straight. Insight generation module 118 of computing system 110 may be configured to generate one or more technical insights, based on the selected importance values of attributes associated with the time series data of a metric. A technical insight may provide narrative and descriptive information regarding why an importance value was selected.

In some examples, insight generation module 118, may be configured to map the value of the attribute to one or more pre-configured technical insights. For instance, computing system 110 may obtain a set of master insights. For instance, computing system 110 may obtain a set of pre-defined insights based on analysis for one or more attributes across each time period associated with the time series data. For one or more importance values, computing system 110 may map the attribute values associated with each importance value to an insight from the set of pre-defined insights to generate a set of final technical insights. For instance, in one example, insight generation module 118 may select importance values of 13, 10.5, and 7, associated with the target met, continuous increase, and maximum attributes, respectively. Insight generation module 118 may map the attribute values associated with the importance values (e.g., four, six, and four, respectively) with insights to generate final technical insights. For instance, insight generation module 118 may generate technical insights, such as those detailing that the metric associated with the attribute has met target for the last four weeks, that the metric has been continuously increasing for the last six weeks, and that the target is at its maximum across the last four weeks. In other examples, insight generation module 118 may be configured to work with one or more components of computing system 110, such as a generative AI model, to generate technical insights for the importance values.

In some examples, insight generation module 118 may output one or more generated technical insights to one or more users of user computing devices 140 (e.g., employees of the organization managing enterprise network 120). Computing system 110 may be configured to obtain feedback from a user regarding the technical insights. Insight generation module 118 may be configured to modify at least one attribute value or ranking value for the time series data based on the user feedback. For instance, in one example, insight generation module 118, in conjunction with other components of computing system 110, may output a technical insight to a user that informs the user that a target for the metric was met for fifteen weeks straight. The user may provide feedback informing insight generation module 118 that they are not interested in whether a target was met or not and are more interested in other attributes. Insight generation module 118, in conjunction with importance assignment module 114, may update the attribute rankings to lower the priority ranking of target met and target not met, while increasing the priority ranking of attributes such as maximum or minimum.

In some examples, insight generation module 118 may transmit or send one or more messages to another computing system, such as one of computing services 150. The one or more messages may include information related to the one or more technical insights. The one or more messages may also include one or more commands, instructions, or other information that the one of computing services 150 may use to perform one or more actions. For instance, insight generation module 118 may generate technical insights related to metrics used to measure the performance of a contact center. Insight generation module 118 may determine that a target was met for a ten-week time span with regards to the average handling time of the contact center. Insight generation module 118 may generate instructions for the one of computing services 150 associated with the contact center to identify any changes or modifications that occurred during the ten week time span should be maintained. For instance, during the time span, the one of computing services 150 may have temporarily allocated additional resources to components of the computing system responsible for automated call assistance. Insight generation module 118 may direct the one of computing services 150 to continue to allocate the additional resources again to more often meet the target average handling time.

FIG. 1 illustrates only one particular example of network system 100. In the example of FIG. 1, network system 100 might include all of the components shown in FIG. 1. However, in other examples, network system 100 may include a subset of the components included and/or may include additional components not shown in FIG. 1. Each of the computing systems and/computing devices illustrated in FIG. 1 (e.g., user computing devices 140, computing services 150, and computing system 110) may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such systems may perform operations described herein as a result of instructions, stored on a computer-readable storage medium, executing on one or more processors. The instructions may be in the form of software stored on one or more local or remote computer readable storage devices. In other examples, one or more of such computing systems may perform operations using hardware, firmware, or a mixture of hardware, software, and firmware residing in and/or executing at each of such computing systems.

The techniques of the disclosure provide one or more technical advantages that realize one or more practical applications. For example, computing system 110 may send one or more insights to one or more other computing systems (e.g., computing services 150) to control or otherwise alter the computing systems. For instance, computing system 110 may cause the one or more computing services 150 to modify configuration settings or change process workflows based on the technical insights generated by insight generation module 118. For instance, computing system 110 may determine that a given week's minimum number of calls accepted at a contact center is highly related to the contact center's overall efficiency and may send a signal for the contact center computing system to increase the number of automated assistants present to receive and answer incoming calls to achieve said minimum. In this way, computing system 110 may proactively improve one of computing services 150 by instructing the one of computing services 150 to perform in a manner determined to increase efficiency and/or improve operations of the one of computing services 150.

In another example, by using one or more generative AI models to generate the attribute rankings, computing system 110 may assist users in generating insights that are not impacted by preexisting thoughts or biases of a user. For instance, in one example, a user may be biased towards the target met attribute, based on previous uses of computing system 110, even if target met is not the best attribute to measure a given metric. By using one or more generative AI models, computing system 110 may generate more accurate, useful, and/or unbiased insights that are not impacted by the biases of the user.

In a further example, computing system 110 may use human feedback (e.g., from one or more users of enterprise network 100) to improve the attribute selection process and/or attribute ranking process of importance assignment module 114. For instance, in one example, if computing system 110 determines a set of five top attributes, a human user could determine that, after further analysis, one or more of the selected attributes are not appropriately ranked (e.g., are not as significant in application as they are in the data) and provide this feedback to computing system 110 via user computing devices 140. Importance assignment module 114 may in turn use the feedback to improve and/or alter one or more internal processes, which may enable insight generation module 118 to generate improved (e.g., more relevant, useful, etc.) technical insights.

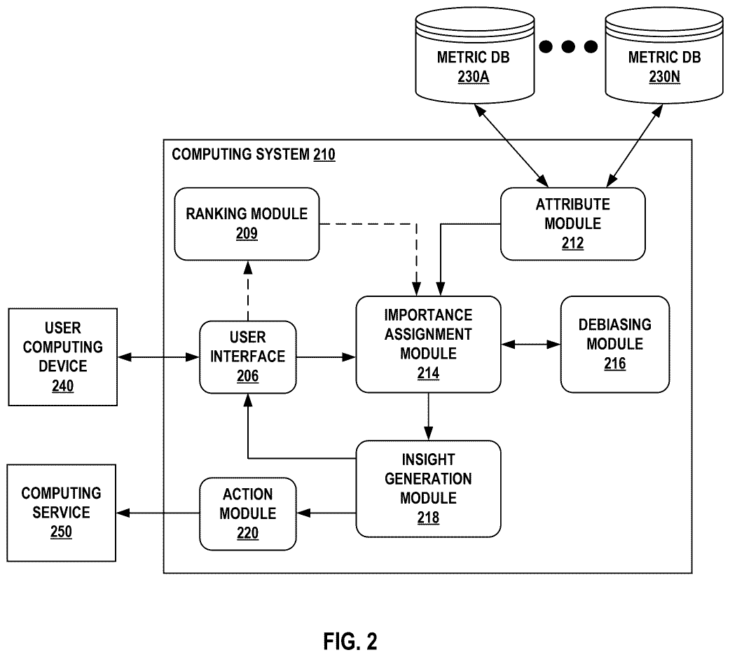

FIG. 2 is a conceptual diagram illustrating an example computing system configured to assign importance values to attributes of time series data of a metric and generate technical insights for the time series data of the metric based on most significant attributes, in accordance with one or more aspects of the present disclosure. Computing system 210 may operate substantially similar to computing system 110 of FIG. 1.

Computing system 210 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 210 may comprise a server within a data center, cloud computing system, server farm, and/or server cluster (or portion thereof) that provides services to client devices and other devices or systems. For example, computing system 210 may host or provide access to services provided by metric databases 230.

Although computing system 210 of FIG. 2 is illustrated as a stand-alone device, in other examples computing system 210 may be implemented in any of a wide variety of ways and may be implemented using multiple devices and/or systems. In some examples, computing system 210 may be, or may be part of, any component, device, or system that includes a processor or other suitable computing environment for processing information or executing software instructions and that operates in accordance with one or more aspects of the present disclosure. In some examples, computing system 210 may be fully implemented as hardware in one or more devices or logic elements.

In the example of FIG. 2, computing system 210 includes a user interface 206, a ranking module 209, an attribute module 212, an importance assignment module 214, a debiasing module 216, an insight generation module 218, and an action module 220. Importance assignment module 214 and insight generation module 218 may operate substantially similar to importance assignment module 114 and insight generation module 118 of computing system 110 of FIG. 1. As shown in the illustrated example of FIG. 2, a user, such as the user of user computing device 240, may interact with computing system 210. User computing device 240 may be any computing device (e.g., phones, tablets, laptops, personal computers, etc.) sufficient to access, utilize, or otherwise interact with computing system 210 through user interface 206.

User computing device 240 may interact with computing system 210 by querying user interface 206 to request generation of technical insights related to a computing service, e.g., computing service 250. A user query may include information identifying one or more computing services, e.g., computing service 250, for which computing system 210 is requested to generate technical insights. For instance, a user query may include information such as the IP address of a computing system associated with computing service 250, the name of computing service 250, or a unique identifier (e.g., identification number, identification code, etc.) associated with computing service 250. Computing system 210 may obtain information related to the selection of one or more metrics (e.g., the metrics computing system 210 should use to generate one or more insights). In some examples, information regarding the selected metrics may be included in the user query. In other examples, computing system 210 may obtain information related to the selected metrics from a database or other storage system associated with computing service 250.

User interface 206 may be a chat bot, communication chat service, communication portal, or other graphical user interface (GUI), such as a browser-based interface or command-line tool. User interface 206 may be connected to the computing system 210 or may be hosted on one or more other computing devices on-premises of the organization. While depicted in the illustrated example of FIG. 2 as part of the on-premises computing system 210, the user interface 206 could also be off-premises of the organization (e.g., hosted in the cloud). User interface 206 may enable a user to enter queries during a communication session.

Importance assignment module 214 may be configured to process and generate technical insights associated with the query. In some scenarios, importance assignment module 214 may obtain a set of user-defined ranking values for attributes, e.g., target met, target not met, continuous increase, continuous decrease, maximum, and minimum, of a metric. For example, the query may include the set of ranking values for the set of attributes. In other examples, important assignment module 214 may obtain the user-defined ranking values from a database or other storage system associated with computing service 250. In further examples, computing system 210 may not obtain user-defined ranking values for the attributes of the metric from the query or for another source. Instead, ranking module 209 may generate the ranking values using one or more machine learning models.

For example, ranking module 209 may be configured to generate a set of ranking values for a set of attributes associated with the metric using one or more generative AI models, such as an LLM, hosted or otherwise accessible by computing system 210. The one or more generative AI models may be trained on one or more technical insights generated by computing system 210 (e.g., through insight generation module 218) and/or the set of rankings associated with the one or more technical insights. For instance, computing system 210 may generate a set of insights regarding a set of metrics from a banking computing service based on a set of rankings obtained from a user associated with the banking computing service (e.g., a data analyst). Computing system 210 may generate a separate set of insights regarding a set of metrics from a contact center computing service, based on a set of rankings obtained from a user associated with the computing service (e.g., an operations manager). Computing system 210 may train the one or more generative AI models on both sets of insights and sets of rankings to improve the capabilities of the one or more generative AI models in determining the relative importance of one attribute in comparison to another (e.g., overall, for a given metric or type of metric, for a given time period across a set of time series data, etc.). In some examples, one or more of the one or more generative AI models may be trained on data specific to one or more computing services, or groups of computing services (e.g., each computing service related to a given computing system, or organizational subunit, of the organization responsible for managing enterprise network 120 of FIG. 1).

Ranking module 209 may obtain a set of ranking values by using the user query to prompt a generative AI model to generate one or more rankings for a given set of attributes. For instance, in some examples, ranking module 209 may be configured to generate a prompt for the generative AI model. For instance, if a user query requests the generation of technical insights related to the average handling time of a contact center computing service, measured weekly across the last year, ranking module 209 may generate a prompt, such as “[I] dentify and rank the most influential attributes for analyzing contact center data to enhance decision-making processes and improve customer service outcomes.” In other examples, ranking module 209 may directly send the user query to the generative AI model, and may include generalized instructions to create a ranking of attributes. Ranking module 209 may use the prompt to request a generative AI model to generate the set of rankings. In some examples, the one or more generative AI models may be directly accessible by user computing device 240 (e.g., allowing users to directly interact with the models and generate a set of attribute rankings).

Metric databases 230 may store information related to the operations of computing service 250. The information stored by metric databases 230 may be one or more metrics that are used to measure or otherwise evaluate the performance of the computing system or associated organization. The metrics stored in metric databases 230 may include information stored across multiple periods of time. For instance, metric database 230A may store information related to a given metric over a period of time. Metric databases 230 may represent any suitable data structure or storage medium for storing information related to logs and/or data from one or more computing services. In some examples, metric databases 230 may be updated and/or maintained by any computing service. In some examples, each of metric databases 230 may contain information specific to a given computing service. For instance, metric database 230A may store information specific to a given computing service, such as a contact center computing service. In other examples, each of metric databases 230 may store information from a multitude of computing services. In some examples, aspects of metric databases 230 may be included within computing system 210. In other examples, some or all of application metric databases 230 may be hosted by and/or accessed through a separate system.

Attribute module 212 may be configured to obtain time series data of one or more metrics from metric databases 230. Attribute module 212 may query metric databases 230 to retrieve information related to the computing service identified in the user query. In some examples, the information retrieved from metric databases 230 may be completed values. For instance, when a computing service stores data related to the average handling time for a given twenty-four-hour period, the data received for a given time period may be the average handling time value (e.g., 10 minutes). In other examples, the metrics stored in metric database 230 may be data that is used to determine a completed value. For instance, when a computing service stores data related to the average handling time for a given twenty-four-hour period, the data stored may be the handling times of each call that occurred in the twenty-four-hour period (e.g., 10 minutes, 12 minutes, 8 minutes). In such examples, attribute module 212 may use the data to determine the complete value of a metric. In some examples, attribute module 212 may perform one or more data validation operations on the data received from metric databases 230. Attribute module 212 may analyze the time series data to find and remove errors (e.g., unreadable characters, datatypes, etc.), inconsistencies, duplications, and missing entries from the dataset.

Attribute module 212 may be configured to determine the value of each attribute associated with a given metric. An attribute may be any computational measurement that may be used to measure (e.g., grade, compare, etc.) a metric from the metric time series data. For instance, determining the value for an attribute at one time period may involve one or more comparisons to other time periods in the time series data. For instance, attribute module 212 may determine one or more attributes based on whether the value of a metric is continuously increasing, continuously decreasing, oscillating, or staying stagnant. To determine the value of the attribute at a given point, attribute module 212 may analyze multiple previous consecutive time periods to determine factors such the duration of the increase/decrease, the rate of increase/decrease, the acceleration of the increase/decrease, the maximum value during the period of the increase/decrease, the minimum value during the period of the increase/decrease, or the average value during the period of the increase/decrease. Attribute module 212 may use these factors to determine a value of an attribute for a metric a given time period.

For instance, in one example, attribute module 212 may determine that one attribute to be analyzed is target met. Attribute module 212 may retrieve metric information over a ten-week period, measured weekly, for the average call handling time measured by a computing service. Attribute module 212 may determine that values, in seconds, for the ten-week period are 739, 744, 749, 754, 764, 753, 770, 764, 734, and 721, wherein the week with a value of 739 represents the latest (e.g., most recent) week in the time series. Attribute module 212 may determine that the target for the given metric is any value under 750. Attribute module 212 may determine whether the values did or did not meet their target over the ten-week period. Attribute module 212 may determine values for the ten-week period are True, True, True, False, False, False, False, False, False, and False. For the latest week in the time series, attribute module 212 may determine the value for the target met attribute is 3, since the target has been met for the last three consecutive time periods. For the second week in the time series, attribute module 212 may determine the value for the target met attribute is 2. For other weeks, such as the seventh week (e.g., the week where the average call handling time was 770), attribute module 212 may determine the value for the target met attribute is 0, since the target has not been met for the given time period.

Importance assignment module 214 may use the set of ranking values obtained from a user, computing system, or the one or more generative AI models to generate unique weights for the attributes associated with the metric. For instance, importance assignment module 214 may assign each attribute a unique weight based on a set of prime numbers, where the highest prime number if given to the highest ranked (e.g., most important) attribute, and the lowest prime number if given to the lowest ranked (e.g., least important) attribute. For instance, in one example, importance assignment module 214 may obtain ranking values of six attributes-target met, target not met, continuous decrease, continuous increase, minimum, and maximum. The ranking values may indicate that the attributes are ranked in the order of minimum, maximum, continuous decrease, continuous increase, target not met, and target met, where minimum is the lowest ranked attribute and target meet is the highest ranked attribute. Importance assignment module 214 may associate prime numbers 2, 3, 5, 7, 11, and 13, with each of the six attributes, accordingly. In some examples, importance assignment module 214 may use the prime numbers to generate additional attribute weightings for each attribute.

Importance assignment module 214 may obtain attribute values of the attributes associated with the metric. Importance assignment module 214 may be configured to automatically identify the most significant attributes associated with the time series data of the metric. Importance assignment module 214 may assign a unique weight, or importance value, to each attribute associated with the time series data of the metric. Importance assignment module 214 may be configured to assign unique differential importance values to each attribute. Importance assignment module 214 may be configured to assign the importance values based on the attribute value of each attribute and the ranking value of the attribute. For instance, importance assignment module 214 may be configured to assign importance values such that a first attribute with an attribute value higher than a second attribute may be assigned an importance value higher than the second attribute. Importance assignment module 214 may be configured to assign the importance values based on the ranking value of each attribute. For instance, when a first attribute and a second attribute have the same attribute value, but the first attribute is ranked higher than the second attribute, the first attribute may be given a higher importance value than the second attribute. In such ways, the importance value of any attribute may be proportional to the attribute value of the attribute, such that an increase or decrease in the attribute value may increase or decrease the importance value of the attribute, respectively.

For instance, in one example of importance assignment module 214 assigning importance values, importance assignment module 214 may evaluate attributes of a metric during a window of time in the time series data. The metric being measured may be evaluated by three attributes, e.g., target met, target not met, and continuous increase. The attributes may be ranked such that target met is ranked highest, and continuous increase is ranked lowest. The attributes may have a value of two, zero, and four, respectively, indicating that a target has been met for the past two time periods of the time series data, and that the metric has been continuously increasing for the past four time periods. In accordance with these values, importance assignment module 214 may assign an importance value to each attribute, such that target met may have the highest importance value, while target not met may have the lowest importance value (e.g., due to the value of continuous increase being significantly higher than target not met).

In one example, importance assignment module 214 may assign importance values according to the equation

$${log}_{10} ( \frac{( x - 1 ) * ( x - 2 ) * ( {P}^{x + 1} ) * \vert x - 3 \vert !}{\vert x - 1 \vert !} + 1 ) ,$$

where the variable P equates to the weight assigned to an attribute, such as the prime number associated with the attribute, and x refers to the attribute value of the attribute at a given period of time. For instance, in one example, importance assignment module 214 may determine a set of ranking values indicating the selected attributes are target met, target not met, continuous increase, continuous decrease, maximum, and minimum, and are weighted with values of 13, 11, 7, 5, 3, and 2, respectively. Attribute module 212 may obtain metric information over a ten-week period, measured weekly, for the average handle time (AHT) measured by a computing service. The average handle time, in seconds, for each week of the ten-week period are 739, 744, 749, 754, 764, 753, 770, 764, 734, and 721, respectively, wherein the week with a value of 739 represents the latest (e.g., most recent) week in the time series. In this example, the target for the given metric is any value under 750. For the latest week in the time series, attribute module 212 may determine values of 3, 0, 0, 5, 0, and 8 for the target met, target not met, continuous increase, continuous decrease, maximum, and minimum attributes, respectively. Importance assignment module 214 may obtain the attribute values and, in combination with the ranking values, may determine values of 3.3422, 0.0000, 0.0000, 3.4951, 0.0000, and 2.4116, for the target met, target not met, continuous increase, continuous decrease, maximum, and minimum attributes, respectively.

In some instances, the importance values assigned by importance assignment module 214 may include one or more instances of bias or preferential assignment. That is, in some instances, importance assignment module 214 may generate higher importance values for an attribute based on attribute values at less recent points in the time than for more recent points in time (e.g., disregarding the time horizon impact of the attribute values). For instance, importance assignment module 214 may generate importance values for a metric across a fifty-two-week period. Importance assignment module 214 may assign a lower importance value for one attribute at week ten in the time series data than for another attribute at week three in the time period. As such, debiasing module 216 may be configured to eliminate bias and preferential assignment in the importance values by increasing the impact of the time horizon.

Debiasing module 216 may be configured to ensure that, for each time period in the time series data, each importance value is at least equal to the highest importance value of an attribute in the previous time period. For instance, if, at one time period in the time series data, the highest importance value for a set of attributes is ten, debiasing module 216 may be configured to transform the importance values for the set of attributes in the next time period in the time series data so that the lowest importance value is at least equal to ten. In some examples, debiasing module 216 may be configured to remove preferential assignment and bias by transforming the importance values according to the equation F(xᵢ)=0, when

$$i \leq 2 , or 300 \cdot ( \frac{{x}_{i + 1} - {x}_{3}}{{x}_{55} - {x}_{3}} )$$

when i≥3, where the variable i may represent position of the metric in the time period. For instance, in a fifty-three-week time window, week 3 may have a value of i=3. For instance, returning to the above example, debiasing module may determine updated values of 5.7674, 0.0000, 0.0000, 17.2545, 0.0000, and 32.9948 for the target met, target not met, continuous increase, continuous decrease, maximum, and minimum attributes, respectively.

To further illustrate, in one example, debiasing module 216 may obtain a set of importance values for a given metric, measured using six attributes. Table 1, below, is an example of importance values assigned to each attribute during each time period. In this example, Table 1 includes instances of preferential assignment. For example, the value of the target met attribute at week 5 is greater than the value of the minimum attribute at week 15.

TABLE 1

| Week | | | Continuous | Continuous | Target | Target |
|---|---|---|---|---|---|---|
| Number | Minimum | Maximum | Decrease | Increase | Not Met | Met |
| 1 | 0.0000 | 0.0000 | 0.0000 | 0.0000 | 0.0000 | 0.0000 |
| 2 | 0.0000 | 0.0000 | 0.0000 | 0.0000 | 0.0000 | 0.0000 |
| 3 | 1.0000 | 1.4624 | 2.1038 | 2.5378 | 3.1248 | 3.3422 |
| 4 | 1.2553 | 1.9191 | 2.7973 | 3.3808 | 4.1656 | 4.4558 |
| 5 | 1.5315 | 2.3892 | 3.4951 | 4.2255 | 5.2070 | 5.5697 |
| 6 | 1.8195 | 2.8639 | 4.1939 | 5.0706 | 6.2484 | 6.6837 |
| 7 | 2.1139 | 3.3402 | 4.8928 | 5.9157 | 7.2897 | 7.7976 |
| 8 | 2.41162 | 3.817102 | 5.591762 | 6.760784 | 8.331141 | 8.911547 |
| 9 | 2.710963 | 4.294135 | 6.29073 | 7.605882 | 9.372534 | 10.02549 |
| 10 | 3.011147 | 4.771227 | 6.9897 | 8.45098 | 10.41393 | 11.13943 |
| 11 | 3.311754 | 5.248339 | 7.68867 | 9.296078 | 11.45532 | 12.25338 |
| 12 | 3.612572 | 5.725457 | 8.38764 | 10.14118 | 12.49671 | 13.36732 |
| 13 | 3.913496 | 6.202577 | 9.08661 | 10.98627 | 13.5381 | 14.48126 |
| 14 | 4.214473 | 6.679698 | 9.78558 | 11.83137 | 14.5795 | 15.59521 |
| 15 | 4.515476 | 7.156819 | 10.48455 | 12.67647 | 15.62089 | 16.70915 |
| 16 | 4.816493 | 7.63394 | 11.18352 | 13.52157 | 16.66228 | 17.82309 |
| 17 | 5.117517 | 8.111061 | 11.88249 | 14.36667 | 17.70368 | 18.93704 |
| 18 | 5.418543 | 8.588183 | 12.58146 | 15.21176 | 18.74507 | 20.05098 |
| 19 | 5.719572 | 9.065304 | 13.28043 | 16.05686 | 19.78646 | 21.16492 |
| 20 | 6.020601 | 9.542425 | 13.9794 | 16.90196 | 20.82785 | 22.27887 |

Debiasing module 216 may perform transformations on the set of importance values, e.g., according to the above equation, to determine a set of bias-free importance values. Table 2, below, is an example of debiased versions of the importance values included in Table 1. As such, each row in Table 2 may correspond to the same numbered row in Table 1. For instance, value 4.922766, in row 3, column 1 of Table 2, may represent the debiased form of the value 1.000, located in row 3, column 1 of Table 1. The updated values in Table 2 may follow each property of the importance values of Table 1.

TABLE 2

| Week | | | Continuous | Continuous | Target | Target |
|---|---|---|---|---|---|---|
| Number | Minimum | Maximum | Decrease | Increase | Not Met | Met |
| 1 | 0.0000 | 0.0000 | 0.0000 | 0.0000 | 3.229827 | 3.588697 |
| 2 | 0.0000 | 0.0000 | 0.0000 | 0.0000 | 3.987441 | 4.43049 |
| 3 | 4.922766 | 5.528977 | 5.724869 | 5.754793 | 5.766016 | 5.767381 |
| 4 | 10.24923 | 11.22028 | 11.48603 | 11.52224 | 11.53502 | 11.53651 |
| 5 | 15.80438 | 16.96805 | 17.25452 | 17.2915 | 17.30429 | 17.30576 |
| 6 | 21.48168 | 22.7349 | 23.02448 | 23.06102 | 23.07359 | 23.07503 |
| 7 | 27.22218 | 28.50816 | 28.79473 | 28.83057 | 28.84289 | 28.8443 |
| 8 | 32.99482 | 34.28354 | 34.56504 | 34.60014 | 34.61219 | 34.61357 |
| 9 | 38.78369 | 40.05964 | 40.33537 | 40.3697 | 40.38149 | 40.38284 |
| 10 | 44.58069 | 45.83598 | 46.10569 | 46.13926 | 46.15079 | 46.15211 |
| 11 | 50.38177 | 51.6124 | 51.87602 | 51.90882 | 51.92009 | 51.92138 |
| 12 | 56.1849 | 57.38884 | 57.64634 | 57.67838 | 57.68939 | 57.69065 |
| 13 | 61.98905 | 63.16529 | 63.41667 | 63.44795 | 63.45869 | 63.45992 |
| 14 | 67.79371 | 68.94175 | 69.18699 | 69.21751 | 69.22799 | 69.22919 |
| 15 | 73.59862 | 74.7182 | 74.95732 | 74.98707 | 74.99729 | 74.99847 |
| 16 | 79.40366 | 80.49466 | 80.72764 | 80.75663 | 80.76659 | 80.76774 |
| 17 | 85.20877 | 86.27112 | 86.49797 | 86.5262 | 86.53589 | 86.53701 |
| 18 | 91.01391 | 92.04757 | 92.26829 | 92.29576 | 92.30519 | 92.30628 |
| 19 | 96.81906 | 97.82403 | 98.03862 | 98.06532 | 98.07449 | 98.07555 |
| 20 | 102.6242 | 103.6005 | 103.8089 | 103.8349 | 103.8438 | 103.8448 |

Importance assignment module 214 may perform one or more operations on the updated, debiased importance values. Importance assignment module 214 may be configured to select the one or more attributes associated with the time series data of the metric with the most significance (e.g., highest values). For instance, importance assignment module 214 may sort the importance values of the attributes at a given week (e.g., week 20) to determine which attributes have the highest importance values. In the example of Table 2, importance assignment module 214 may sort the importance values of the attributes at week 20 in descending order and determine that target met, target not met, and continuous decrease are the three attributes with the highest importance values.

Insight generation module 218 may be configured to generate one or more technical insights based on the most significant attributes associated with the time series data of a metric. A technical insight may provide narrative and descriptive information regarding why an attribute was selected as being most important or significant for the time period. In some examples, insight generation module 218 may be configured to map the value of the most significant attributes to one or more pre-configured technical insights. For instance, computing system 210 may obtain a set of pre-defined insights based on analysis for one or more attributes across each time period associated with the time series data. For one or more importance values, computing system 210 may map the attribute values associated with each importance value to an insight from the set of pre-defined insights to generate a set of final technical insights. For instance, in one example, insight generation module 218 may select importance values of 13, 10.5, and 7, associated with the target met, continuous increase, and maximum attributes, respectively. Insight generation module 218 may map the attribute values associated with the importance values (e.g., four, six, and four, respectively) with insights to generate final technical insights. For instance, insight generation module 218 may generate technical insights, such as those detailing that the metric associated with the attribute has met target for the last four weeks, that the metric has been continuously increasing for the last six weeks, and that the target is at its maximum across the last four weeks. In other examples, insight generation module 218 may work with one or more components of computing system 210, such as a generative AI model, to generate technical insights for the importance values.

In some examples, insight generation module 218 may output one or more generated technical insights to user computing device 240 (e.g., in conjunction with user interface 206). Computing system 210 may be configured to obtain feedback from a user regarding the technical insights output to the user (e.g., via user interface 206). Computing system 210 may be configured to modify at least one attribute value or ranking value for the time series data based on the user feedback. For instance, in one example, insight generation module 218, via user interface 206, may output a technical insight to a user that informs the user that the attribute value with the highest associated importance value indicates the target for the metric was met for fifteen weeks straight. The user may provide feedback (e.g., through user interface 206) that the user or the business unit is not interested in whether a target was met or not, and are more interested in other attributes, such as the maximum or minimum of a metric. Computing system 210, in conjunction with components such as ranking module 209 and/or importance assignment module 214, may update the attribute rankings to lower the priority ranking of target met and target not met, while increasing the priority ranking of attributes such as maximum or minimum, and regenerate the importance values for each attribute for the metric across the given time period. Insight generation module 218 may send updated insights back to user computing device 240 (e.g., using user interface 206).

In some examples, action module 220 may be configured to transmit or send one or more messages to another computing system, such as computing service 250. The one or more messages may include information related to the one or more technical insights. The one or more messages may also include one or more commands, instructions, or other information that computing service 250 may use to perform one or more actions. For instance, in one example, action module 220 may obtain information indicating that a target was met for a ten-week time span with regards to the average handling time of a contact center. Action module 220 may generate instructions for computing service 250, associated with the contact center, to identify any changes or modifications that occurred during the ten-week time span should be maintained. For instance, during the time span, the computing system associated with computing service 250 may have temporarily allocated additional resources to components of the computing system responsible for automated call assistance. Action module 220 may generate one or more additional instructions that may direct computing service 250 to continue to allocate the additional resources (e.g., to more often meet the target average handling time).

FIG. 2 illustrates only one particular example of network system 100. In the example of FIG. 2, computing system 200 might include all of the components shown in FIG. 2. However, in other examples, computing system 200 may include a subset of the components included and/or may include additional components not shown in FIG. 2.

Computing system 200, as is illustrated in FIG. 2, may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such devices may perform operations described herein as a result of instructions, stored on a computer-readable storage medium, executing on one or more processors. The instructions may be in the form of software stored on one or more local or remote computer readable storage devices. In other examples, one or more of such computing devices may perform operations using hardware, firmware, or a mixture of hardware, software, and firmware residing in and/or executing at each of such computing devices.

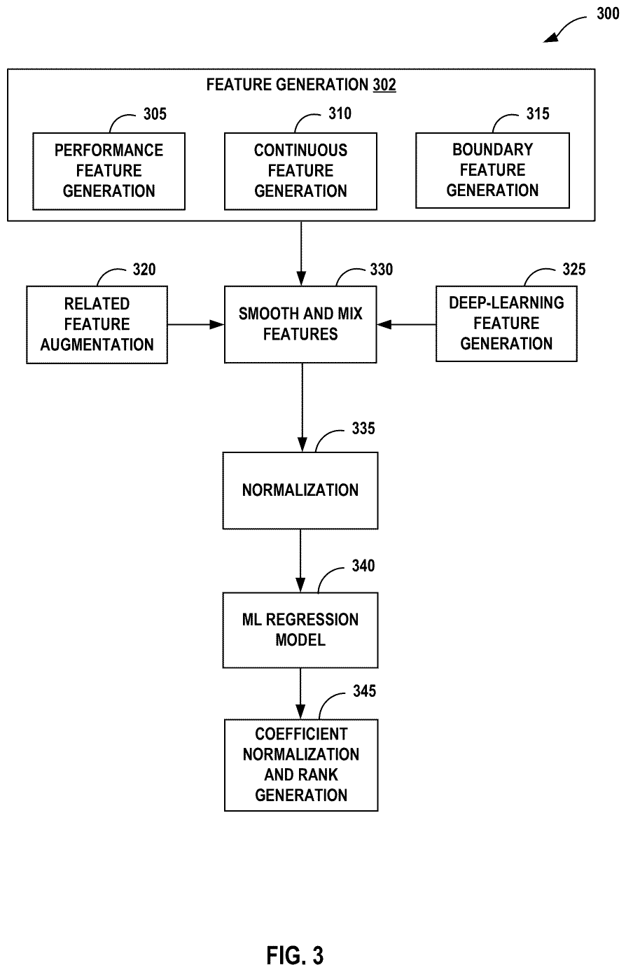

FIG. 3 is a flow diagram illustrating example operations of training one or more machine learning (ML) models to generate a set of ranking values for attributes, in accordance with one or more techniques of this disclosure. FIG. 3 may be described in relation to computing system 210 of FIG. 2, and, more specifically, ranking module 209 of computing system 210.

Ranking module 209 may generate features based on time series data (e.g., as obtained from metric databases 230 of FIG. 2) (302). Ranking module 209 may generate features based on metric data included in any time series data. For instance, ranking module 209 may generate various performance features (305). A performance feature may include any feature generated by ranking module 209 that evaluates the performance of a metric with respect to a given target. For instance, a performance feature may include features such as target met or target not met.

Ranking module 209 may generate various continuous features (310). A continuous feature may include any features that are used to gauge the performance of attributes measured on a continuous scale (e.g., how a given value changes across the time series). For instance, ranking module 209 may generate various features to measure the change of a feature over time, such as the duration of a period of continuous increase/decrease, the rate of continuous increase/decrease during a period of continuous increase/decrease, the acceleration of continuous increase/decrease during a period of continuous increase/decrease, the maximum value during a period of continuous increase/decrease, the minimum value during a period of continuous increase/decrease, and/or the average value during a period of continuous increase/decrease.

Ranking module 209 may generate various boundary features (315). A boundary feature may include any features that are used to gauge the performance of a metric with respect to the performance of the metric across other time periods. For instance, a boundary feature may include the maximum or minimum of a metric over a given time period.

Ranking module 209 may conduct related feature augmentation on the features previously generated or otherwise already established (320). For instance, ranking module 209 may conduct one or more data manipulation or transformation operations to the features of the time series data to create additional data for one or more models to use. For instance, ranking module 209 may warp (e.g., stretch or compress a time axis), jitter (e.g., add noise to various numeric values), scale, permutate (e.g., rearrange, swap, etc.), or differentiate (e.g., generate one or more differentials for a value) data in the time series to increase the training dataset. Ranking module 209 may use these techniques to generate various features, such as those detailing non-linear trend identifications, seasonality, and/or standard deviation.

Ranking module 209 may generate various features using one or more deep-learning techniques (325). For instance, ranking module 209 may use one or more deep learning models to automatically generate one or more new features. The deep learning model(s) may be trained to extract and generate high-level representations of the time series data, generating features that more accurately represent complex patterns across the time series data and/or are not as easily noticed and/or captured by individuals conducting manual feature generation. In some examples, the one or more deep learning models may comprise at least one Recurrent Neural Networks (RNNs) or Long Short-Term Memory (LSTM) models, that may be better suited to capture temporal trends across the time series data.

Ranking module 209 may smooth and mix the generated features (330) to improve the dataset prior to training. For instance, attribute module 209 may smooth the features generated in steps 305, 310, 315, 320, and 325 to reduce noise and further highlight patterns or features estimated to have a higher importance. For instance, ranking module 209 may detect trends in noisy data and features (e.g., where trends are unclear or difficult to determine). Ranking module 209 may mix multiple features to increase the diversity (e.g., breadth, scope, etc.) of the feature set (e.g., by providing further generalization, data, etc.). For instance, in one example, ranking module 209 may mix two time-series signals using weighted interpolation. In another example, ranking module 209 may generate features by averaging multiple features together.

Ranking module 209 may conduct normalization operations on the feature set (335). Ranking module 209 may conduct the normalization operations to ensure that the features are easy to compare (e.g., standardized) and bias-free by standardizing the range (e.g., maximum and minimum) of features. For instance, ranking module 209 may scale or otherwise transform the data using a technique such as min-max scaling, mean normalization, z-score normalization, robust scaling (e.g., using median, interquartile range, etc.), log transformation, power transformation, or L1/L2 normalization (e.g., vector normalization).

Ranking module 209 may use the features to train one or more ML regression models (340). The one or more ML regression models may include a linear regression model, a ridge regression model, a lasso regression model, a random forest regression model, and/or a gradient boosting model. Ranking module 209 may be configured to split the feature set into separate training and testing datasets (e.g., to prevent overfitting). In some instances, ranking module 209 may tune one or more parameters in the training process to enhance the capabilities of the one or more ML regression models. In other examples, ranking module 209 may remove one or more features from the feature set and/or may generate one or more new features. Ranking module 209 may use the one or more ML regression models to normalize coefficients and generate a set of ranking values for attributes associated with a metric (345). For instance, on the basis of the coefficient normalization, ranking module 209 may be configured to determine the rankings for various attributes, such as determining a given attribute from a set of ten attributes is ranked highest and so on for the entire set of attributes.

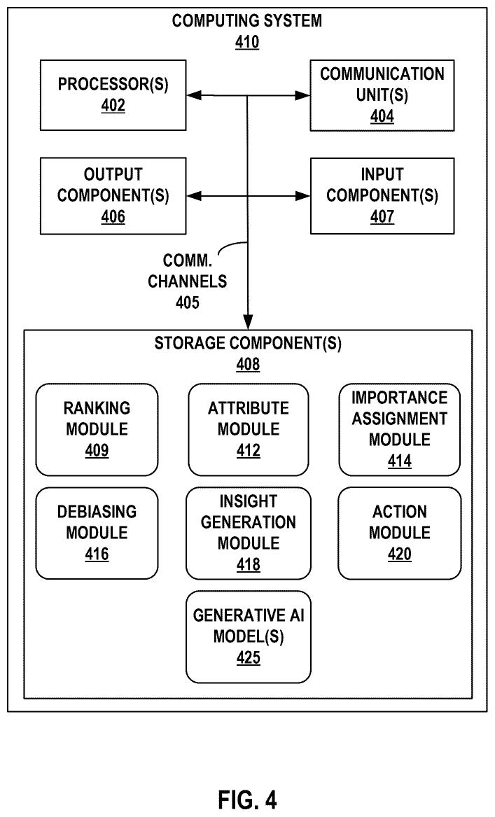

FIG. 4 is a block diagram illustrating an example computing system 410, in accordance with one or more aspects of the present disclosure. In the example of FIG. 4, computing system 410 includes a ranking module 409, an attribute module 412, an importance assignment module 414, a debiasing module 416, an insight generation module 418, and an action module 420. Computing system 410 may generally correspond to the computing system 110 of FIG. 1 and/or computing system 210 of FIG. 2. Accordingly, ranking module 409, attribute module 412, debiasing module 416, and action module 420 may perform some or all of the same functions described as being performed by computing system 110 from FIG. 1 or ranking module 209, attribute module 212, debiasing module 216, and action module 220 of FIG. 2. Similarly, importance assignment module 414 and insight generation module 418 may perform some or all of the same functions described as being performed by importance assignment module 114 and insight generation module 118 from FIG. 1 or importance assignment module 214 and insight generation module 218 from FIG. 2, respectively.

Computing system 410 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 410 may comprise a server within a data center, cloud computing system, server farm, and/or server cluster (or portion thereof) that provides services to client devices and other devices or systems.

Although computing system 410 of FIG. 4 is illustrated as a stand-alone device, in other examples computing system 410 may be implemented in any of a wide variety of ways and may be implemented using multiple devices and/or systems. In some examples, computing system 410 may be, or may be part of, any component, device, or system that includes a processor or other suitable computing environment for processing information or executing software instructions and that operates in accordance with one or more aspects of the present disclosure. In some examples, computing system 410 may be fully implemented as hardware in one or more devices or logic elements. In the example of FIG. 4, computing system 410 may include one or more processors 402, one or more communication units 404, one or more output components 406, one or more input components 407, one or more communication channels 405, and one or more storage components 408. In the illustrated example, storage components 408 include ranking module 409, attribute module 412, importance assignment module 414, debiasing module 416, insight generation module 418, and action module 420. One or more of the devices, modules, storage areas, or other components of computing system 410 may be interconnected to enable inter-component communications (physically, communicatively, and/or operatively).

Communication channels 405 may interconnect each of the components 402, 404, 406, 407, and/or 408 for inter-component communications (physically, communicatively, and/or operatively). In some examples, communication channels 405 may include a system bus, a network connection, an inter-process communication data structure, or any other method for communicating data.

A power source (not shown) provides power to one or more components of computing system 410. In some examples, the power source may receive power from the primary alternative current (AC) power supply in a commercial building or data center, where some or all of an enterprise network may reside. In other examples, the power source may be or may include a battery.

One or more processors 402 of computing system 410 may implement functionality and/or execute instructions associated with computing system 410 associated with one or more modules illustrated herein and/or described below. One or more processors 402 may be, may be part of, and/or may include processing circuitry that performs operations in accordance with one or more aspects of the present disclosure. Examples of processors 402 include microprocessors, application processors, display controllers, auxiliary processors, one or more sensor hubs, and any other hardware configured to function as a processor, a processing unit, or a processing device. Computing system 410 may use one or more processors 402 to perform operations in accordance with one or more aspects of the present disclosure using software, hardware, firmware, or a mixture of hardware, software, and firmware residing in and/or executing at computing system 410.

One or more communication units 404 of computing system 410 may communicate with devices external to computing system 410 by transmitting and/or receiving data, and may operate, in some respects, as both an input device and an output device. In some examples, communication units 404 may communicate with other devices over a network. In other examples, communication units 404 may send and/or receive radio signals on a radio network such as a cellular radio network. In other examples, communication units 404 of computing system 410 may transmit and/or receive satellite signals on a satellite network such as a Global Positioning System (GPS) network. Examples of communication units 404 include a network interface card (e.g., such as an Ethernet card), an optical transceiver, a radio frequency transceiver, a GPS receiver, or any other type of device that may send and/or receive information. Other examples of communication units 404 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 407 may represent any input devices of computing system 410 not otherwise separately described herein. One or more input devices 407 may generate, receive, and/or process input from any type of device capable of detecting input from a human or machine. For example, one or more input devices 407 may generate, receive, and/or process input in the form of electrical, physical, audio, image, and/or visual input (e.g., peripheral device, keyboard, microphone, camera). For computing devices that may be used by a user, one or more input devices 407 may generate or receive input from a keyboard, pointing device, voice responsive system, video camera, button, sensor, mobile input device, control pad, microphone, presence-sensitive screen, network, or any other type of device for detecting input from a human or machine.

One or more output devices 406 may represent any output devices of computing system 410 not otherwise separately described herein. One or more output devices 406 may generate, receive, and/or process input from any type of device capable of detecting input from a human or machine. For example, one or more output devices 406 may generate, receive, and/or process output in the form of electrical and/or physical output (e.g., peripheral device, actuator). For computing devices that may be used by a user, one or more output devices 406 may generate, present, and/or process output in the form of tactile, audio, visual, video, and other output. Some devices may serve as both input and output devices. For example, a communication device may both send and receive data to and from other systems or devices over a network.

One or more storage components 408 within computing system 410 may store information for processing during operation of computing system 410. Storage components 408 may include one or more types of storage such as hard disk drives, solid state drives (e.g., SATA drives, NVMe drives, eMMC storage, etc.), magnetic tape drives, remote storage (e.g., cloud storage), and/or other types of storage. Storage components 408 may store program instructions and/or data associated with one or more of the modules described in accordance with one or more aspects of this disclosure. One or more processors 402 and one or more storage components 408 may provide an operating environment or platform for such modules, which may be implemented as software, but may in some examples include any combination of hardware, firmware, and software. One or more processors 402 may execute instructions and one or more storage components 408 may store instructions and/or data of one or more modules. The combination of processors 402 and storage components 408 may retrieve, store, and/or execute the instructions and/or data of one or more applications, modules, or software. Processors 402 and/or storage components 408 may also be operably coupled to one or more other software and/or hardware components, including, but not limited to, one or more of the components of computing system 410 and/or one or more devices or systems illustrated as being connected to computing system 410.

In some examples, one or more storage components 408 are temporary memories, meaning that a primary purpose of the one or more storage components is not long-term storage. Storage components 408 of application computing system 410 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Storage components 408, in some examples, also include one or more computer-readable storage media. Storage components 408 may be configured to store larger amounts of information than volatile memory. Storage components 408 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

Storage components 408, as illustrated in FIG. 4, includes ranking module 409, attribute module 412, importance assignment module 414, debiasing module 416, insight generation module 418, and action module 420. Although not illustrated in the example of FIG. 4, computing system 410 may include an operating system. The operating system may perform foundational functions capable of being invoked by various modules executing on centralized computing system 410. In some examples, the operating system may include a user interface service library that may perform functions relating to presenting audio, visual, or other information, such as through audio devices, display screens, haptic feedback devices, or otherwise. The operating system may also act as an interface for receiving input from a user, through touch interactions, voice commands, or otherwise. Further, the operating system may provide token processing and/or token abstraction services that may be accessed by and/or leveraged by modules and/or applications executing on computing system 410.

Ranking module 409 may be configured to create a set of rankings for each attribute that is used to evaluate a metric. For instance, ranking module 409 may be configured to work with one or more of generative AI model(s) 425. Ranking module 409 may generate one or more prompts for generative AI models 425, which cause generative AI models 425 to generate a set of attribute rankings. Generative AI models 425 may include a type of model such as GPT, Claude, BLOOM, LLaMA, Mistral 7B, or any other similar model known in the art. In some examples, the one or more generative AI models may be a transforming model, such as a large language model (LLM). In other examples, generative AI models 425 may be another type of question-answering transformer models, such as Bidirectional Encoder Representations from Transformers (BERT), Robustly Optimized BERT Pretraining Approach (ROBERTa), Text-To-Text Transfer Transformer (T5), or any other similar model known in the art. Generative AI models 425 may be trained to determine a set of attribute rankings for a set of attributes. In some examples, computing system 410 may be configured to retrain generative AI models 425 periodically (e.g., to incorporate new data). In some examples, such as where computing system 410 (e.g., in conjunction with components such as insight generation module 418) regenerates one or more technical insights in response to feedback from a user, computing system 410 may be configured to retrain generative AI models 425 (e.g., to incorporate the user feedback into the one or more models).

Attribute module 412 may be configured to obtain time series data of one or more metrics. In some examples, attribute module 412 may determine what metrics to obtain data related to based on a user query. In other examples, attribute module 412 may determine what metrics to obtain data for based on information stored on one or more other computing systems, such as a default metric list associated with a specific computing service. Attribute module 412 may query a database (e.g., metric databases 230 of FIG. 2) to retrieve information related to the computing service identified in the user query. Attribute module 412 may be configured to determine the value of each attribute associated with a given metric.

Importance assignment module 414 may use a set of rankings, obtained from a user or from the one or more generative AI models, to generate unique weights for each attribute in the set of rankings. For instance, importance assignment module 414 may assign each attribute a unique weight based on a set of prime numbers, where the highest prime number if given to the highest ranked (e.g., most important) attribute, and the lowest prime number if given to the lowest ranked (e.g., least important) attribute. Importance assignment module 414 may be configured to assign a unique weight, or importance value, to each attribute associated with the time series data of the metric based on the ranking values (e.g., weights) and attributes values. Importance assignment module 414 may be configured to assign a unique differential importance value to each attribute. Importance assignment module 414 may be configured to assign the importance values based on the value of each attribute. In some examples, importance assignment module 414 may assign importance values according to the equation

$${log}_{10} ( \frac{( x - 1 ) * ( x - 2 ) * ( {P}^{x + 1} ) * \vert x - 3 \vert !}{\vert x - 1 \vert !} + 1 ) ,$$

where the variable P equates to the weight assigned to an attribute, such as the prime number associated with the attribute, and x refers to the value of the attribute at a given period of time.

Debiasing module 216 may be configured to eliminate bias and preferential assignment in the importance values by increasing the impact of the time horizon in the time series data. Debiasing module 416 may be configured to ensure that, for each time period in the time series data, each importance value is at least equal to the highest importance value of an attribute in the previous time period. In some examples, debiasing module 416 may be configured to remove preferential assignment and bias by transforming the importance values according to the equation F(xᵢ)=0, when i≤2, or

$$300 \cdot ( \frac{{x}_{i + 1} - {x}_{3}}{{x}_{55} - {x}_{3}} )$$

when i≥3, where the variable i may represent position of the metric in the time period. For instance, in a fifty-three-week time window, week 3 may have a value of i=3. Based on the debiased values, importance assignment module 414 may be configured to select the one or more importance values associated with the time series data of the metric with the most significance. For instance, importance assignment module 414 may sort the importance values to determine the highest importance values.

Insight generation module 418 may be configured to generate one or more technical insights, based on the selected importance values of attributes associated with the time series data of a metric. In some examples, insight generation module 418 may be configured to map the value of the attribute to one or more pre-configured technical insights. For instance, computing system 410 may obtain a set of pre-defined insights based on analysis for one or more attributes across each time period associated with the time series data. For one or more importance values, computing system 410 may map the attribute values associated with each importance value to an insight from the set of pre-defined insights to generate a set of final technical insights. In other examples, insight generation module 418 may work with one or more of generative AI models 425 to generate technical insights for the importance values.

In some examples, insight generation module 418 may output one or more generated technical insights to another computing device and/or computing system (e.g., any of user computing devices 140 of FIG. 1). Computing system 410 may obtain feedback from a user regarding the technical insights output to the user. Insight generation module 418 may be configured to modify at least one attribute value or ranking value for the time series data based on the user feedback. For instance, insight generation module 418, in conjunction with other components (e.g., ranking module 409, importance assignment module 414, debiasing module 416, etc.), may update the attribute rankings or ranking values and regenerate the importance values for each attribute for a metric across a given time period. Insight generation module 418 may send updated insights back to the user.

In some examples, action module 420 may obtain the one or more technical insights generated by insight generation module 418. Action module 420 may be configured to transmit or send one or more messages to another computing system (e.g., a computing system responsible for managing any of computing services 150 of FIG. 1). The one or more messages may include information related to the one or more technical insights. The one or more messages may also include one or more commands, instructions, or other information that a computing service may use to perform one or more actions.

FIG. 4 illustrates only one particular example of computing system 400. In the example of FIG. 4, computing system 400 might include all of the components shown in FIG. 4. However, in other examples, computing system 400 may include a subset of the components included or may include additional components not shown in FIG. 4.

Computing system 400, as is illustrated in FIG. 4, may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such devices may perform operations described herein as a result of instructions, stored on a computer-readable storage medium, executing on one or more processors. The instructions may be in the form of software stored on one or more local or remote computer readable storage devices. In other examples, one or more of such computing devices may perform operations using hardware, firmware, or a mixture of hardware, software, and firmware residing in and/or executing at each of such computing devices.

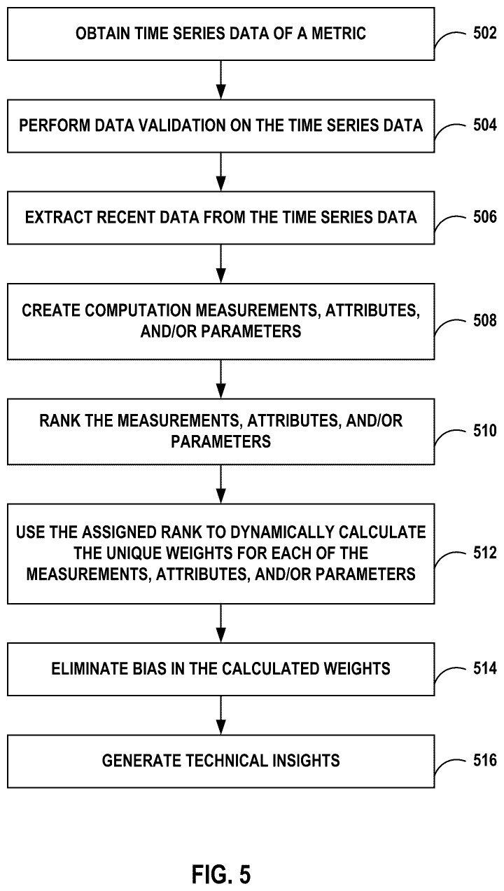

FIG. 5 is a flow diagram illustrating an example operation of generating technical insights based on significant attributes of time series data of a metric, in accordance with one or more aspects of the present disclosure. FIG. 5 is described below within the context of computing system 410 of FIG. 4. In other examples, operations described in FIG. 5 may be performed by one or more other components, modules, systems, or devices. Further, in other examples, operations described in connection with FIG. 5 may be merged, performed in a different sequence, omitted, or may encompass additional operations not specifically illustrated or described.

In the process illustrated in FIG. 5, and in accordance with one or more aspects of the present disclosure, computing system 410 obtains time series data of a metric (502). For example, components of computing system 410 (e.g., attribute model 412) may obtain time series data of a metric from one or more databases (e.g., metric databases 230 of FIG. 2). In some examples, computing system 410 may obtain the time series data in response to receiving one or more queries from one or more users (e.g., user computing devices 140 of FIG. 1).

Computing system 410 performs data validation on the time series data (504). For instance, computing system 410 may perform data validation to ensure that data is accurate free of errors. For instance, computing system 410 may filter through the time series data to ensure that only data relevant to the given metric was selected. Computing system 410 may check for missing values (e.g., in one or more time periods across the time series). Computing system 410 may determine whether a given metric includes at least a certain number of periods with a value. Computing system 410 extracts recent data from the time series data (506). For instance, computing system 410 may extract the recent history from the exhaustive dataset (e.g., all of the metric data stored in the one or more databases).

Computing system 410 creates computation measurements, attributes, and/or parameters (508). For instance, components of computing system 410 (e.g., attribute module 412) may be configured to determine the value of each attribute associated with a given metric. In some examples, such as where the attribute relates to maximum or minimum, the value of an attribute may relate to the value of the attribute at previous time periods. In other examples, such as where the attribute is related to a continuous feature or a performance feature, the value of an attribute may relate to the value of the attribute at a number of consecutive time periods prior to the current time. For instance, an attribute value for target met may relate to the value of the attribute as consecutive time periods during which the respective attribute is true for the corresponding value of the metric.

Computing system 410 ranks the measurements, attributes, and/or parameters (510). In some examples, a user query may include the set of ranking values for the set of attributes. In other examples, computing system 410 may obtain the user-defined ranking values from a database or other storage system associated with a specified computing service. In further examples, computing system 410 may not obtain user-defined ranking values for the attributes of the metric from the query or for another source. Instead, computing system 410 (e.g., in conjunction with components such as ranking module 409) may generate the ranking values using one or more machine learning models (e.g., generative AI models 425).

Computing system 410 uses the assigned rank to dynamically calculate the unique weights for each of the measurements, attributes, and/or parameters (512). Computing system 410, in conjunction with components such as importance assignment module 414, may be configured to assign a unique weight, or importance value, to each attribute associated with the time series data of the metric. Computing system 410 may be configured to assign unique differential importance values to each attribute. Computing system 410 may be configured to assign the importance values based on the value of each attribute and the ranking of the attribute. Computing system 410 eliminates bias in the calculated weights (514). Computing system 410 (e.g., in conjunction with components such as debiasing module 416) may be configured to ensure that, for each time period in the time series data, each importance value is at least equal to the highest importance value of an attribute in the previous time period.

Computing system 410 generates technical insights (516). Computing system 410, in conjunction with components such as insight generation module 418, may select the one or more importance values associated with the time series data of the metric with the most significance (e.g., highest values). Computing system 410 may generate one or more technical insights, based on the selected importance values of attributes associated with the time series data of a metric. A technical insight may provide narrative and descriptive information regarding why an importance value was selected. In some examples, computing system 410 may be configured to map the value of the attribute to one or more pre-configured technical insights. Computing system 410 may map the attribute values associated with the selected importance values to one or more of the pre-configured technical insights to generate a set of final insights.

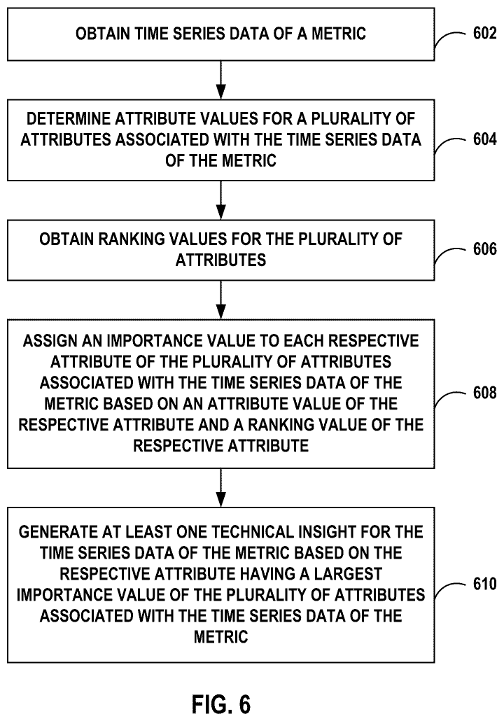

FIG. 6 is a flow diagram illustrating an example operation of assigning importance values to attributes of time series data of a metric and generating technical insights for the time series data of the metric based on most significant attributes, in accordance with one or more techniques of this disclosure. FIG. 6 is described below within the context of computing system 410 of FIG. 4. In other examples, operations described in FIG. 6 may be performed by one or more other components, modules, systems, or devices. Further, in other examples, operations described in connection with FIG. 6 may be merged, performed in a different sequence, omitted, or may encompass additional operations not specifically illustrated or described.

In the process illustrated in FIG. 6, and in accordance with one or more aspects of the present disclosure, computing system 410 obtains time series data of a metric (602). For example, components of computing system 410 (e.g., attribute model 412) may obtain time series data of a metric from one or more databases (e.g., metric databases 230 of FIG. 2). In some examples, computing system 410 may obtain the time series data in response to receiving one or more queries from one or more users (e.g., user computing devices 140 of FIG. 1). In some examples, the values obtained may correspond to each time period of a plurality of time periods within a window of time prior to a current time.

Computing system 410 determines attribute values for a plurality of attributes associated with the time series data of the metric (604). For instance, components of computing system 410 (e.g., attribute module 412) may be configured to determine the value of each attribute associated with a given metric. In some examples, such as where the attribute relates to maximum or minimum, the value of an attribute may relate to the value of the attribute at previous time periods. In other examples, such as where the attribute is related to a continuous feature or a performance feature, the value of an attribute may relate to the value of the attribute at a number of consecutive time periods prior to the current time. For instance, an attribute value for target met may relate to the value of the attribute as consecutive time periods during which the respective attribute is true for the corresponding value of the metric.

Computing system 410 obtains ranking values for the plurality of attributes (606). In some examples, computing system 410 may generate the ranking values for the plurality of attributes using one or more generative artificial intelligence (AI) models (e.g., generative AI models 425). In other examples, computing system 410 may obtain the ranking values for the plurality of attributes from a user of the system. In some examples, the ranking values for the plurality of attributes indicate a priority order of the plurality of attributes. In some examples, the ranking values for the plurality of attributes comprise prime numbers such that the importance value assigned to each respective attribute is unique among the plurality of attributes.

Computing system 410 assigns an importance value to each respective attribute of the plurality of attributes associated with the time series data of the metric based on an attribute value of the respective attribute and a ranking value of the respective attribute (608). In some examples, computing system 410 may calculate the importance value of the respective attribute for each time period of the plurality of time periods within the window of time prior to the current time. In some examples, computing system 410 may transform the importance value of the respective attribute based on importance values of the respective attribute for different time periods of the plurality of time periods within the window of time prior to the current time in order to remove assignment bias from the importance value.

Computing system 410 generates at least one technical insight for the time series data of the metric based on the respective attribute having a largest importance value of the plurality of attributes associated with the time series data of the metric (610). Computing system 410 may select the one or more importance values associated with the time series data of the metric with the most significance (e.g., highest values). Computing system 410 may generate one or more technical insights, based on the selected importance values of attributes associated with the time series data of a metric. In some examples, computing system 410 may output the one or more technical insight for the time series data of the metric for display on a user computing device. Computing system 410 may obtain, from the user computing device, user feedback with respect to the at least one technical insight for the time series data of the metric. Computing system 410 may modify at least one of the attribute values for the plurality of attributes or the ranking values for the plurality of attributes based at least in part on the user feedback. In some examples, computing system 410 may message to another computing system to cause the another computing system to perform an action based on the at least one technical insight for the time series data of the metric.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, a limited number of devices or systems are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A system comprising:
a memory; and
one or more processors in communication with the memory and configured to:
obtain time series data of a metric;
determine attribute values for a plurality of attributes associated with the time series data of the metric;
obtain ranking values for the plurality of attributes;
assign an importance value to each respective attribute of the plurality of attributes associated with the time series data of the metric based on an attribute value of the respective attribute and a ranking value of the respective attribute; and
generate at least one technical insight for the time series data of the metric based on the respective attribute having a largest importance value of the plurality of attributes associated with the time series data of the metric.

2. The system of claim 1, where the one or more processors are further configured to:
output the at least one technical insight for the time series data of the metric for display on a user computing device;
obtain, from the user computing device, user feedback with respect to the at least one technical insight for the time series data of the metric; and
modify at least one of the attribute values for the plurality of attributes or the ranking values for the plurality of attributes based at least in part on the user feedback.

3. The system of claim 1, where the one or more processors are further configured to send a message to another computing system to cause the another computing system to perform an action based on the at least one technical insight for the time series data of the metric.

4. The system of claim 1, wherein to obtain the ranking values for the plurality of attributes, the one or more processors are configured to generate the ranking values for the plurality of attributes using one or more generative artificial intelligence (AI) models.

5. The system of claim 1, wherein to obtain the ranking values for the plurality of attributes, the one or more processors are configured to obtain the ranking values for the plurality of attributes from a user of the system.

6. The system of claim 1, wherein to obtain the time series data of the metric, the one or more processors are configured to obtain a value of the metric corresponding to each time period of a plurality of time periods within a window of time prior to a current time.

7. The system of claim 6, wherein to determine the attribute value for the respective attribute of the plurality of attributes associated with the time series data of the metric, the one or more processors are configured to determine a number of consecutive time periods prior to the current time during which the respective attribute is true for the corresponding value of the metric.

8. The system of claim 6, wherein to assign the importance value to the respective attribute of the plurality of attributes associated with the time series data of the metric, the one or more processors are configured to calculate the importance value of the respective attribute for each time period of the plurality of time periods within the window of time prior to the current time.

9. The system of claim 8, wherein the one or more processors are configured to transform the importance value of the respective attribute based on importance values of the respective attribute for different time periods of the plurality of time periods within the window of time prior to the current time in order to remove assignment bias from the importance value.

10. The system of claim 1, wherein the ranking values for the plurality of attributes indicate a priority order of the plurality of attributes.

11. The system of claim 1, wherein the ranking values for the plurality of attributes comprise prime numbers such that the importance value assigned to each respective attribute is unique among the plurality of attributes.

12. The system of claim 1, wherein to generate the at least one technical insight for the time series data of the metric, the one or more processors are configured to generate a human readable description of behavior of the metric over time corresponding to the respective attribute having the largest importance value of the plurality of attributes associated with the time series data of the metric.

13. A method comprising:
obtaining time series data of a metric;
determining attribute values for a plurality of attributes associated with the time series data of the metric;
obtaining ranking values for the plurality of attributes;
assigning an importance value to each respective attribute of the plurality of attributes associated with the time series data of the metric based on an attribute value of the respective attribute and a ranking value of the respective attribute; and
generating at least one technical insight for the time series data of the metric based on the respective attribute having a largest importance value of the plurality of attributes associated with the time series data of the metric.

14. The method of claim 13, further comprising:
outputting the at least one technical insight for the time series data of the metric for display on a user computing device;
obtaining, from the user computing device, user feedback with respect to the at least one technical insight for the time series data of the metric; and
modifying at least one of the attribute values for the plurality of attributes or the ranking values for the plurality of attributes based at least in part on the user feedback.

15. The method of claim 13, further comprising sending a message to another computing system to cause the another computing system to perform an action based on the at least one technical insight for the time series data of the metric.

16. The method of claim 13, wherein obtaining the ranking values for the plurality of attributes comprises generating the ranking values for the plurality of attributes using one or more generative artificial intelligence (AI) models.

17. The method of claim 13, wherein obtaining the ranking values for the plurality of attributes comprises obtaining the ranking values for the plurality of attributes from a user of the system.

18. The method of claim 13, wherein obtaining the time series data of the metric comprises obtaining a value of the metric corresponding to each time period of a plurality of time periods within a window of time prior to a current time.

19. The method of claim 18, wherein determining the attribute value for the respective attribute of the plurality of attributes associated with the time series data of the metric comprises determining a number of consecutive time periods prior to the current time during which the respective attribute is true for the corresponding value of the metric.

20. Non-transitory computer-readable storage media encoded with instructions that, when executed, cause one or more processors to:
obtain time series data of a metric;
determine attribute values for a plurality of attributes associated with the time series data of the metric;
obtain ranking values for the plurality of attributes;
assign an importance value to each respective attribute of the plurality of attributes associated with the time series data of the metric based on an attribute value of the respective attribute and a ranking value of the respective attribute; and
generate at least one technical insight for the time series data of the metric based on the respective attribute having a largest importance value of the plurality of attributes associated with the time series data of the metric.
